(19) United States
(12) Patent Application Publication
(10) Pub. No.: US 2023/0207971 A1
(43) Pub. Date: Jun. 29, 2023

(54) BATTERY MODULE FLEX CIRCUIT

(71) Applicant: RIVIAN IP HOLDINGS, LLC, Irvine, CA (US)

(72) Inventor: Tyler Collins, Irvine, CA (US)

(21) Appl. No.: 17/833,362

(22) Filed: Jun. 6, 2022

Related U.S. Application Data
(60) Provisional application No. 63/294,284, filed on Dec. 28, 2021.

(51) Int. Cl. H01M 50/519; H01M 50/509; H01M 10/48; H01M 50/569

(52) U.S. Cl. CPC H01M 50/519; H01M 50/509; H01M 10/482; H01M 50/569

(57) ABSTRACT

A battery module and a method of manufacturing a battery module are provided. The battery module includes a plurality of current collectors configured to electrically connect battery cells of the battery module together, and a flex circuit. The battery module is configured to have a number of electrical connections between the plurality of current collectors and the flex circuit. The flex circuit comprises a number of connection terminals, each capable of being electrically coupled to a current collector of the plurality of current collectors. The number of connection terminals is greater than the number of electrical connections. The electrical connections are made between the plurality of current collectors and a subset of the connection terminals of the flex circuit.

### CROSS-REFERENCE TO RELATED APPLICATION

This application claims priority to U.S. Provisional Patent Application No. 63/294,284, filed on Dec. 28, 2021, the entire contents of which are hereby expressly incorporated by reference in their entirety.

### INTRODUCTION

The present disclosure is directed to a flex circuit (e.g., a flexible printed circuit board) for a battery module, a battery module including the universal flex circuit, and a method of manufacturing the battery module, and more particularly, to a universal flex circuit that is able to be installed in different battery module configurations while avoiding monitoring errors.

### SUMMARY

It is advantageous to provide battery module monitoring circuitry to monitor the operating voltage of battery cells, or groups thereof, within a battery module. In some embodiments, in order to avoid routing wires through the battery module to connect the battery cells to the battery module monitoring circuitry, it is advantageous to use a flex circuit including a plurality of conductive traces for connecting battery module monitoring circuitry to the battery cells. For example, in one approach, the conductive traces of the flex circuit may connect a battery current collector assembly, including a plurality of current collectors, to battery module monitoring circuitry in order to monitor the voltage of each parallel group of battery cells in the battery module. However, if the number of parallel groups of battery cells in a battery module is changed for different applications (e.g., based on the voltage and current requirements for the battery module), the flex circuit and the battery module monitoring circuitry must be redesigned or reconfigured. For example, if conductive traces of the flex circuit are not centered on each parallel group of battery cells, measurement errors due to increased direct current internal resistance (DCIR) may be introduced. Accordingly, in some embodiments, it would be advantageous to provide a universal flex circuit and battery module monitoring circuitry that is able to accurately monitor different battery configurations of a battery module.

To solve one or more of these problems, a flex circuit for a battery module, a battery module including the universal flex circuit, and a method of manufacturing the battery module are provided. The battery module includes a plurality of current collectors configured to electrically connect battery cells together, and a flex circuit. The battery module is configured to have a number of electrical connections between the plurality of current collectors and the flex circuit. The flex circuit includes a number of connection terminals, each capable of being electrically coupled to a current collector of the plurality of current collectors. The number of connection terminals is greater than the number of electrical connections, and the electrical connections are made between the plurality of current collectors and a subset of the connection terminals of the flex circuit.

In some embodiments, the connection terminals may include one or more voltage tap locations; the battery cells may be arranged into n−1 number of a plurality of groups; and the plurality of current collectors may include n number of current collectors configured to electrically connect the battery cells in each of the plurality of groups in parallel with each other and electrically connect each of the plurality of groups in series with each other.

In some embodiments, the number of electrical connections may be equal to n and the second number of terminals is greater than n.

In some embodiments, the number of electrical connections may be equal to 2n and the second number of terminals may be greater than 2n.

In some embodiments, the flex circuit may further include a plurality of conductive traces and a plurality of output terminals. In some embodiments, for each of the plurality of conductive traces, one of the connection terminals may be connected to a first end of the conductive trace and one of the output terminals may be connected to a second end of the conductive trace.

In some embodiments, only a subset of the output terminals, which are connected to the subset of the connection terminals, may be configured to be electrically coupled to a voltage-measuring device configured to measure a voltage level at the subset of the connection terminals of the flex circuit.

In some embodiments, the voltage-measuring device may be selected from a plurality of types of configurations of voltage-measuring devices, based on the number of electrical connections made between the plurality of current collectors and the subset of the connection terminals of the flex circuit.

In some embodiments, the battery module may further include an adaptor configured to selectively electrically connect a subset of the plurality of output terminals to the voltage-measuring device, based on the number of electrical connections made between the plurality of current collectors and the subset of the connection terminals of the flex circuit.

In some embodiments, the flex circuit may extend from one side of the battery module across the battery module along a first direction and each of the plurality of current collectors may include: a spine that traverses the battery module along a second direction substantially perpendicular to the first direction; and a plurality of projections that extend from the spine. In some embodiments, for each of the plurality of current collectors, a connection terminal, among the connection terminals, that is closest to the spine of the current collector may be selected as the connection terminal to be electrically connected to the current collector.

In some embodiments, a battery module is provided. The battery module includes a plurality of current collectors configured to electrically connect battery cells together, and a flex circuit. The battery module is configured for determining a number of measurements of the plurality of current collectors. The flex circuit includes a number of connection terminals, each capable of being electrically coupled to a current collector of the plurality of current collectors. The number of connection terminals is greater than the number of measurements. A first current collector of the plurality of current collectors includes one and only one electrical connection to the flex circuit for one of the measurements, and a second current collector of the plurality of current collectors includes two electrical connections to the flex circuit for a corresponding one of the measurements.

In some embodiments, the connection terminals may include one or more voltage tap locations; the flex circuit may further include a plurality of conductive traces and a plurality of output terminals; and for each of the plurality of conductive traces, one of the connection terminals may be connected to a first end of the conductive trace and one of the output terminals is connected to a second end of the conductive trace.

In some embodiments, the flex circuit may extend from one side of the battery module across the battery module along a first direction, and each of the plurality of current collectors may include a spine that traverses the battery module along a second direction substantially perpendicular to the first direction, and a plurality of projections that extend from the spine. In some embodiments, for the first current collector, the one and only electrical connection to the flex circuit may be by a first connection terminals. In some embodiments, for the second current collector, the two electrical connections to the flex circuit may be by second and third connection terminals. In some embodiments, the first connection terminal may be closer to the spine of the first current collector than either of the second and third connection terminals is to the spine of the second current collector.

In some embodiments, for each of the first, second, and third connection terminals, the corresponding output terminals may be configured to be electrically connected to a voltage-measuring device.

In some embodiments, the voltage-measuring device may be configured to combine the output terminals corresponding to the second and third connection terminals for one of the measurements.

In some embodiments, the voltage-measuring device may include an adaptor configured to combine the output terminals corresponding to the second and third connection terminals.

In some embodiments, the battery module may further include a voltage-measuring device configured to determine the number of measurements, and a connector configured to electrically connect the flex circuit to the voltage-measuring device.

In some embodiments, a method of manufacturing is provided. The method of manufacturing includes providing a flex circuit to be installed in a battery module including a current collector configuration for electrically connecting a plurality of batteries, the flex circuit including a connector. The method of manufacturing further includes selecting a voltage-measuring device of a first configuration from a plurality of types of configurations of voltage-measuring devices, based on the current collector configuration of the battery module; installing the flex circuit in the battery module; and coupling the selected voltage-measuring device to the connector of the flex circuit.

In some embodiments, the flex circuit may include a number of connection terminals, each capable of being electrically connected to a current collector. Installing the flex circuit in the battery module may include making a number of electrical connections between the current collector configuration and a subset of the connection terminals of the flex circuit, the number of connection terminals being greater than the number of electrical connections.

In some embodiments, the flex circuit may include a number of connection terminals, each capable of being electrically connected to a current collector. Installing the flex circuit in the battery module may include making one and only one electrical connection between a first current collector of the current collector configuration and the connection terminals of the flex circuit for a first measurement of the first current collector, and making two electrical connections between a second current collector of the current collector configuration and two of the connection terminals of the flex circuit for a second measurement of the second current collector.

In some embodiments, selecting the voltage-measuring device of the first configuration may include selecting an adaptor configured to route certain electrical output terminals of the flex circuit to certain input terminals of the voltage-measuring device, based on the current collector configuration of the battery module.

### BRIEF DESCRIPTION OF THE DRAWINGS

The above and other objects and advantages of the present disclosure will be apparent upon consideration of the following detailed description, taken in conjunction with the accompanying drawings, in which like reference characters refer to like parts throughout, and in which:

FIG. 1 shows a perspective view of a battery submodule, in accordance with some embodiments of the present disclosure;

FIG. 2 shows a partial perspective view of a current collector assembly including a plurality of current collectors of the battery submodule, in accordance with some embodiments of the present disclosure;

FIG. 3 shows a perspective view of a battery module made up of two of the battery submodules of FIG. 1 coupled to opposite sides of a cooling plate 302, in accordance with some embodiments of the present disclosure;

FIG. 4 shows a perspective view of first and second flex circuits and processing circuitry with the remainder of the battery module hidden from view, in accordance with some embodiments of the present disclosure;

FIG. 5 shows a top view of the battery module with a first configuration of a first battery submodule and a first configuration of the first flex circuit, in accordance with some embodiments of the present disclosure;

FIG. 6 shows a top view of the battery module with the first configuration of the first battery submodule of FIG. 5 and a second configuration of the first flex circuit, in accordance with some embodiments of the present disclosure;

FIG. 7 shows a partial view of a connection of one pair of first terminals of the first flex circuit to one of the plurality of current collectors, in accordance with some embodiments of the present disclosure; and

FIG. 8 shows a block diagram of an adapter for connecting the first flex circuit to the processing circuitry, in accordance with some embodiments of the present disclosure.

### DETAILED DESCRIPTION

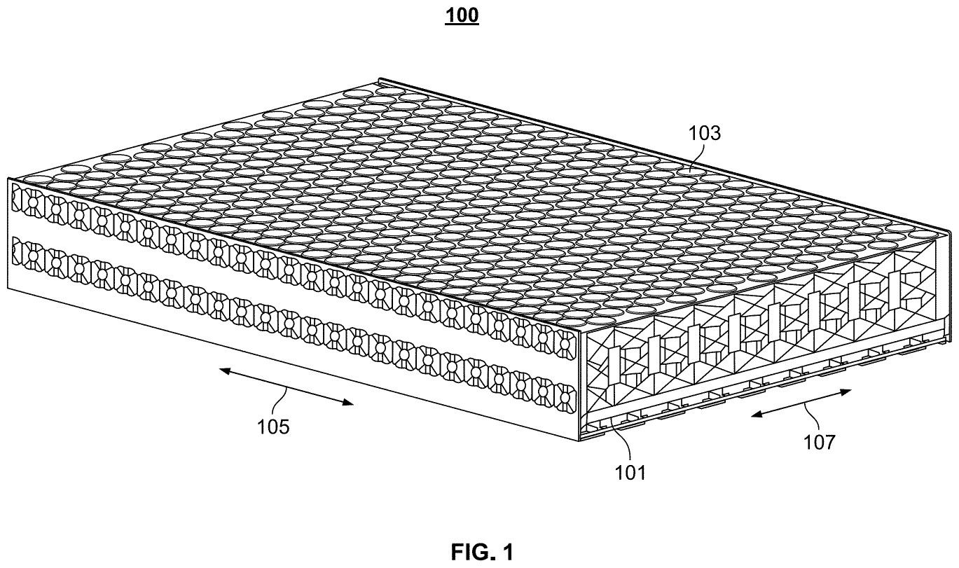

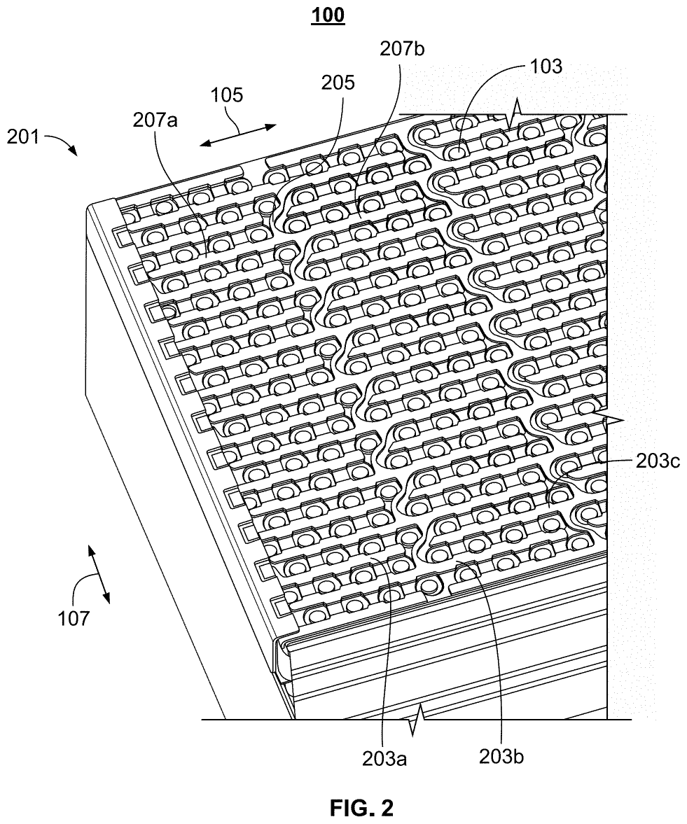

FIG. 1 shows a perspective view of a battery submodule 100, in accordance with some embodiments of the present disclosure. As shown, the battery submodule 100 may include a cell tote 101 populated with a plurality of battery cells 103. Although the cell tote 101 is shown as being fully populated by the battery cells 103 (e.g., each cell position within the cell tote 101 is populated by a battery cell 103), certain battery cell positions with the cell tote 101 may be depopulated based on the requirements of the battery submodule 100. Additionally, the plurality of battery cells 103 may be arranged in a plurality of parallel groups. In some embodiments, the number of parallel groups may be varied based on the requirements of the battery submodule 100 (e.g., to change the voltage of battery submodule 100). As explained in greater detail below with reference to FIG. 2, the battery submodule 100 may include a current collector assembly including a plurality of current collectors electrically connecting the battery cells 103 in each of the plurality of groups in parallel with each other and electrically connecting each of the plurality of groups in series with each other. In some embodiments, each of the plurality of groups of the battery cells 103 in battery submodule 100 may be arranged sequentially along a first direction 105 (e.g., connected in series along the first direction 105). The first direction 105 may be a lengthwise direction perpendicular to a second direction 107 (e.g., a widthwise direction).

FIG. 2 shows a partial perspective view of a current collector assembly 201 including a plurality of current collectors 203 (203a, 203b, 203c) of the battery submodule 100, in accordance with some embodiments of the present disclosure. In some embodiments, the plurality of current collectors 203 may comprise aluminum. As shown, the plurality of current collectors 203 connects the battery cells 103 in parallel and series, as described above. For example, in some embodiments, a first electrical terminal (e.g., the anode) of each of a first group of the plurality of battery cells 103 may be connected to a first current collector 203a; the second electrical terminal (e.g., the cathode) of each of the first group of the plurality of battery cells 103 may be connected to a second current collector 203b; the first electrical terminal of each of a second group of the plurality of battery cells 103 may be connected to the second current collector 203b; the second electrical terminal of each of the second group of the plurality of battery cells 103 may be connected to a third current collector 203c; the first electrical terminal of each of a third group of the plurality of battery cells 103 may be connected to the third current collector 203c, and so on. That is, the groups of the first plurality of battery cells may be arranged along the first direction 105. However, this is only one example, and the plurality of battery cells 103 may be connected in any suitable manner.

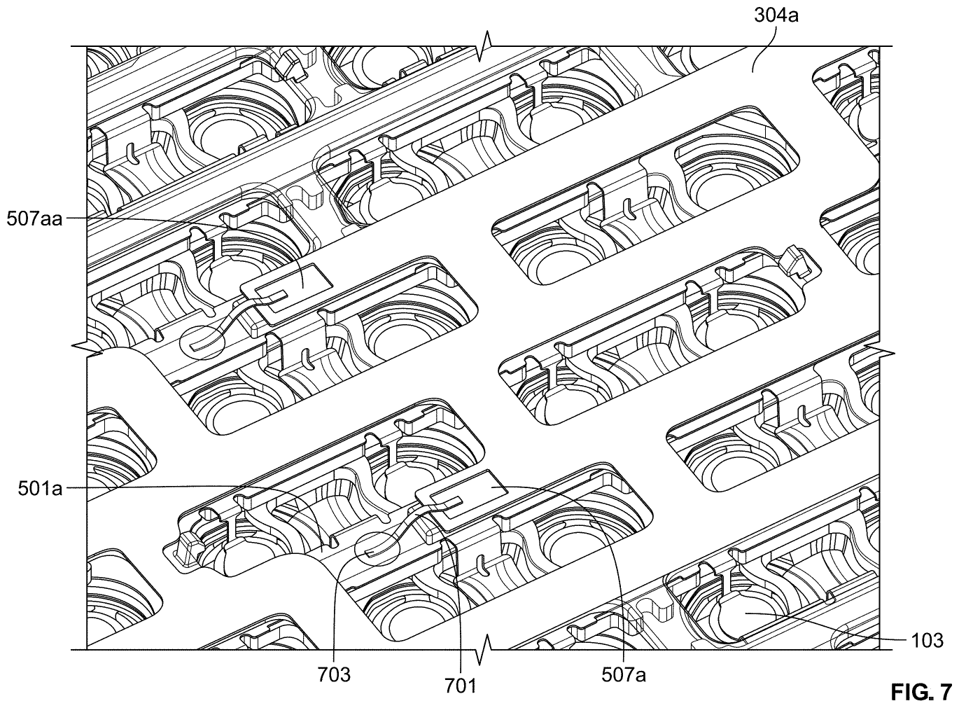

As shown, each of the plurality of current collectors 203 includes a spine that traverses the battery submodule 100 substantially along the second direction 107 and a plurality of projections that extend perpendicular to the spine (e.g., along the first direction 105 substantially perpendicular to the spine). For example, the second current collector 203b includes a spine 205 and a plurality of projections 207a, 207b. Each of the plurality of current collectors 203 may be electrically connected to the battery cells 103 in any suitable manner (e.g., through welded tab), as illustrated in further detail with reference to FIG. 7.

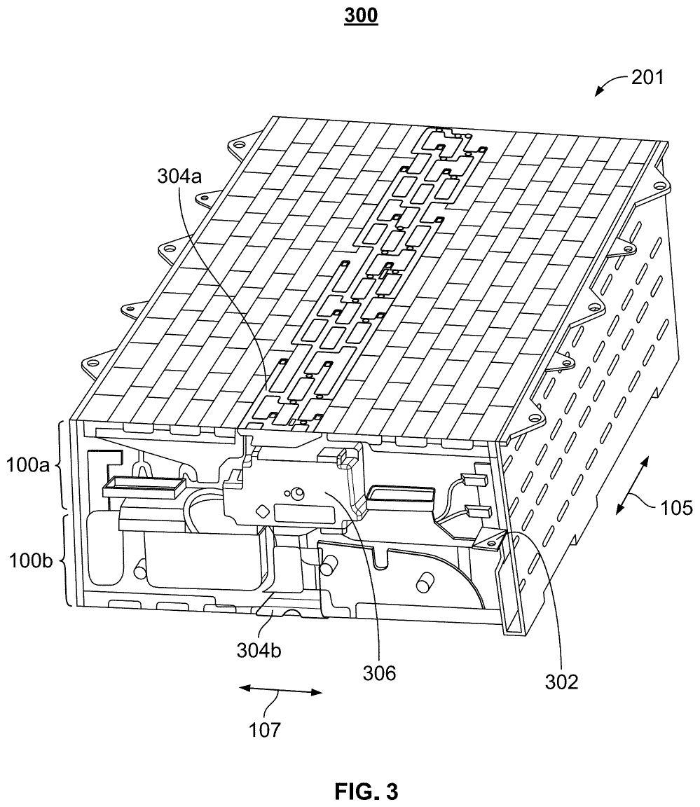

FIG. 3 shows a perspective view of a battery module 300 made up of two of the battery submodules 100 of FIG. 1 coupled to opposite sides of a cooling plate 302, in accordance with some embodiments of the present disclosure. As shown, a first battery submodule 100a may be coupled to a top surface of the cooling plate 302 and a second battery submodule 100b may be coupled to a bottom surface of the cooling plate 302, opposite to the top surface. Although the battery module 300 includes two battery submodules 100a and 100b, it should be understood that the battery module 300 may include a single battery submodule. As shown, the battery module 300 may include a first flex circuit 304a and a second flex circuit 304b. As used herein, a flex circuit may refer to the first flex circuit 304a or the second flex circuit 304b. As shown, the first flex circuit 304a may be installed on a top surface of the first battery submodule 100a (e.g., a top surface of the battery module 300), and the second flex circuit 304b may be installed on a top surface of the second battery submodule 100b (e.g., a bottom surface of the battery module 300). The second flex circuit 304b may be substantially similar to the first flex circuit 304a. Thus, for convenience of description, only the first flex circuit 304a and the first battery submodule 100a are described below in detail.

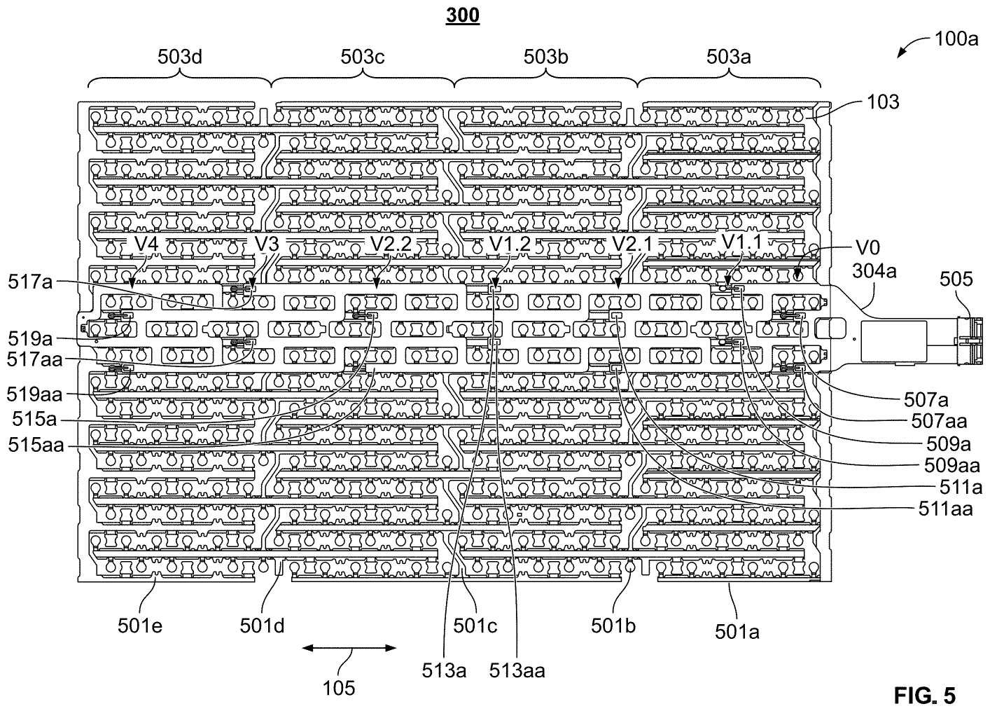

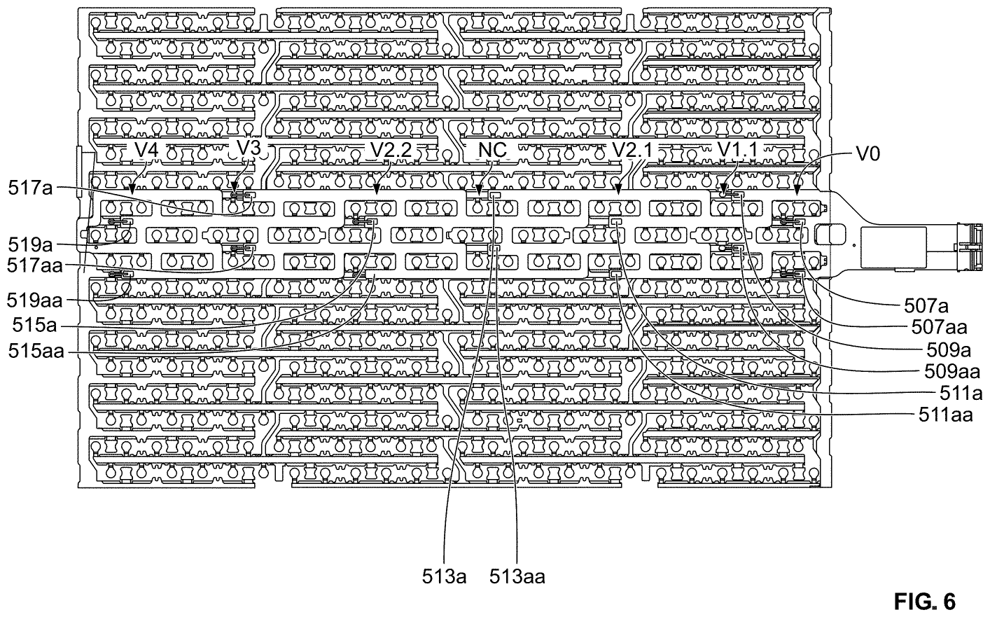

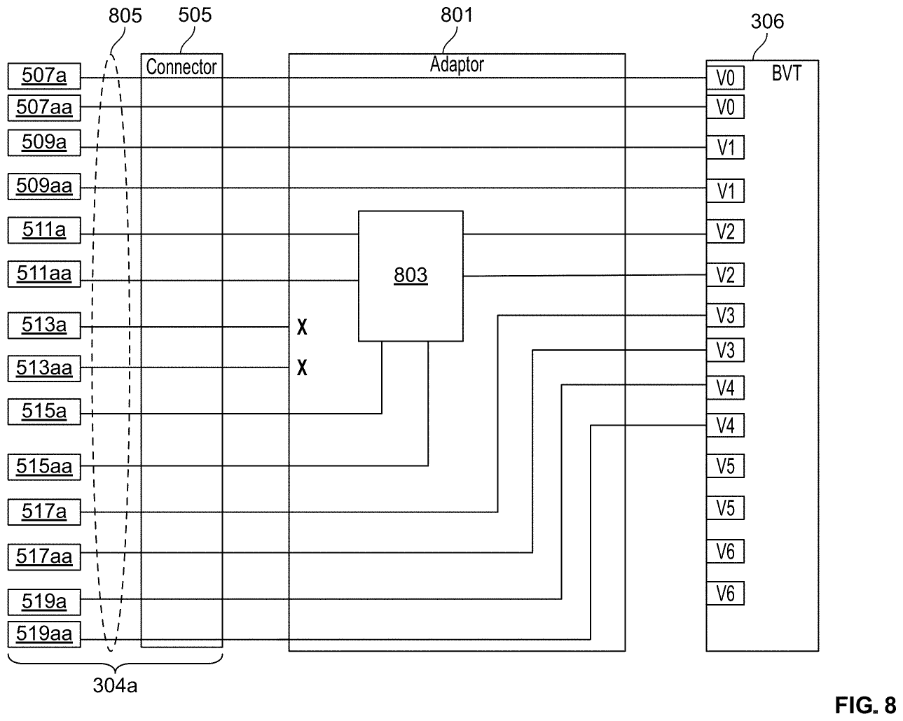

As shown, the first flex circuit 304a may have a first end connected to processing circuitry 306 (e.g., a battery voltage and temperature (BVT) acquisition unit) mounted on a side of the battery module 300, and may extend from the first end across a middle portion of the top surface of the first battery submodule 100a to a second end opposite the first end. In some embodiments, the middle portion corresponds to the midline plus and minus 10%, 15%, 20%, or 25% of the width. In some embodiments, the first flex circuit 304a comprises at least two parallel segments that are positioned above respective projections of the plurality of current collectors (e.g., redundant paths). For example, as shown in greater detail in, e.g., FIGS. 5 and 6, the at least two parallel segments may be positioned above respective projections of the current collectors that are generally perpendicular to the spines (e.g., the first flex circuit 304a corresponds to a portion of the pattern of the plurality of current collectors 203 shown in FIG. 2), such that the at least two parallel segments may be shielded from a battery experiencing a thermal runaway event. As described in greater detail below, a first one of the at least two parallel segments may include a first plurality of conductive traces, and a second one of the at least two parallel segments may include a second plurality of conductive traces. As explained in greater detail below with reference to FIGS. 5-8, each of the first and second plurality of conductive traces may include a plurality of connection terminals capable of being connected with one of the plurality of current collectors 203 and a plurality of output terminals capable of being connected with the processing circuitry 306. In some embodiments, the first flex circuit 304a may be connected to the processing circuitry through an adaptor, as explained in greater detail below with reference to FIG. 8. In some embodiments, the plurality of output terminals may be omitted from the first flex circuit 304a.

The processing circuitry 306 may include any suitable circuitry for processing signals received from the conductive traces of the first and second flex circuits 304a, 304b. For example, the processing circuitry 306 may include signal conditioning circuitry (e.g., filters, amplifiers, voltage dividers), an analog-to-digital converter, any other suitable circuitry, or any combination thereof. In some embodiments, the processing circuitry may include a processor, a power supply, power management components (e.g., relays, filters, voltage regulators), input/output (I/O) (e.g., GPIO, analog, digital), memory, communications equipment (e.g., CAN bus hardware, Modbus hardware, or a Wi-Fi module), any other suitable components, or any combination thereof. In some embodiments, the processing circuitry 306 may include one or more microprocessors, microcontrollers, digital signal processors, programmable logic devices, field-programmable gate arrays (FPGAs), application-specific integrated circuits (ASICs), etc., and may include a multi-core processor. In some embodiments, the processing circuitry 306 may be distributed across multiple separate processors or processing units, for example, multiple of the same type of processing units or multiple different processors.

In some embodiments, the processing circuitry 306 executes instructions stored in memory for monitoring a battery system (e.g., including the battery module 300), managing a battery system, or both. In some embodiments, memory may be an electronic storage device that is part of the processing circuitry 306. For example, memory may be configured to store electronic data, computer software, or firmware, and may include random-access memory, read-only memory, hard drives, optical drives, solid-state devices, or any other suitable fixed or removable storage devices, and/or any combination of the same. Nonvolatile memory may also be used (e.g., to launch a boot-up routine and other instructions). In some embodiments, the processing circuitry 306 may be coupled to more than one battery module (e.g., via any suitable number of cables and connectors), corresponding to more than one battery module.

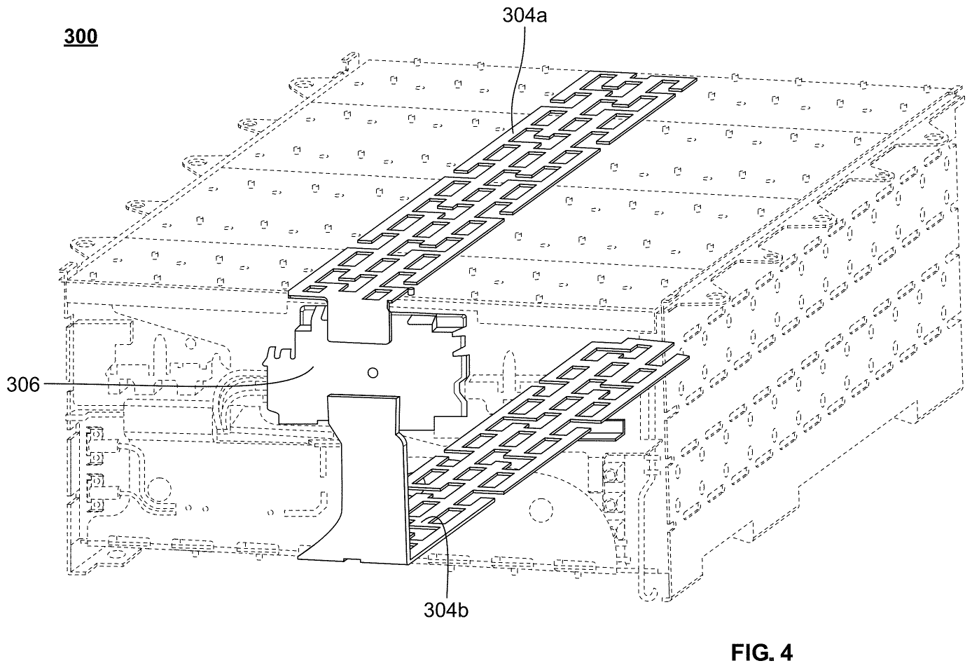

FIG. 4 shows a perspective view of the first and second flex circuits 304a, 304b and the processing circuitry 306 with the remainder of the battery module 300 hidden from view, in accordance with some embodiments of the present disclosure. As shown, the processing circuitry 306 may be mounted on a sidewall of the battery module 300. In some embodiments, the processing circuitry 306 may be mounted closer to the top surface of the first battery submodule 100a. In this case, the second flex circuit 304b may be longer than the first flex circuit 304a and extend up the sidewall of the battery module 300 to connect to the processing circuitry 306. However, this is only an example, and the processing circuitry 306 may be mounted equidistant from the top surface and the bottom surface of the battery module 300, or closer to the bottom surface of the battery module 300.

FIG. 5 shows a top view of the battery module 300 with a first configuration of the first battery submodule 100a and a first configuration of the first flex circuit 304a, in accordance with some embodiments of the present disclosure. As shown, the first battery submodule 100a includes five current collectors 501 (501a, 501b, 501c, 501d, 501e) for connecting the plurality of battery cells 103 into four parallel groups 503 (503a, 503b, 503c, 503d) (e.g., each at a different operating voltage), and for connecting the four parallel groups 503 in series with each other. However, it should be understood that this is only one possible configuration and that the battery cells 103 may be connected into any other suitable number of parallel groups (e.g., 2, 3, 5, 6, 7, 8, 9, etc.), depending on the requirements of the battery module 300.

The first flex circuit 304a may be a universal flex circuit that is configured to connect n number of parallel groups of battery cells 103 to the processing circuitry 306, where n is the maximum number of parallel groups that are expected among the different anticipated configurations of the battery submodule 100a. In this manner, the same universal flex circuit may be used for any battery submodule configuration with n or fewer parallel groups of battery cells 103. Put another way, the same universal flex circuit is capable of being used with multiple battery submodule configurations (e.g., of a battery module) having different numbers of current collectors (e.g., less than or equal to n+1). For example, as shown in FIG. 5, first flex circuit 304a is capable of being used with battery submodule configurations having seven or fewer current collectors. In some embodiments, to do this, the universal flex circuit may be configured with a number of first terminals that is greater than n+1 number of parallel groups (e.g., to optimize alignment between the first terminals and current collectors for certain configurations of the battery module 100a). If the universal flex circuit includes redundant conductive traces for each of the parallel groups (e.g., two terminals per parallel group as shown), the universal flex circuit may be configured with a number of pairs of connection terminals that is greater than n+1 number of parallel groups. In some embodiments, the universal flex circuit may be configured with a number of connection terminals that is equal to n+1 number of parallel groups. If the universal flex circuit includes redundant conductive traces for each of the parallel groups (e.g., two terminals per parallel group as shown), the universal flex circuit may be configured with a number of pairs of connection terminals that is equal to n+1 number of parallel groups. For example, as shown, if the maximum number of parallel groups that are expected for the battery submodule 100a is six, the first flex circuit 304a is configured with seven pairs of connection terminals (507a and 507aa; 509a and 509aa; 511a and 511aa; 513a and 513aa; 515a and 515aa; 517a and 517aa; 519a and 519aa) (e.g., voltage tap locations) corresponding to the number of current collectors (e.g., seven) required to connect the battery cells into the six parallel groups and to the number of measurements of the current collector. Thus, for battery submodules configured with fewer than six parallel groups of battery cells 103 (e.g., the four parallel groups 503 shown in FIG. 5), the number of pairs of the connection terminals 507-519 (e.g., seven pairs) is greater than the number of parallel groups plus one (e.g., four+one). As another example, if a battery submodule configuration has eight parallel groups of battery cells 103, connected by nine current collectors, a universal flex circuit is required to have at least nine connection terminals (or nine pairs of connection terminals), which may be spaced along the length of the universal flex circuit. It should be understood that such a universal flex circuit is capable of being used for any battery submodule configuration with eight or fewer parallel groups of battery cells 103.

However, in cases in which the number of the pairs of connection terminals 507-519 is greater than the number of parallel groups plus one (e.g., less than six parallel groups), certain current collectors among the plurality of current collectors 501 may not have a pair of the connection terminals 507-519 that is substantially centered on the current collector (e.g., located on or near the spine of the current collector). In this case, measurement errors (e.g., voltage measurement errors) at these current collectors (e.g., due to the increased DCIR) may be introduced. Accordingly, in some embodiments, it may be advantageous to average measurements from different pairs of the connection terminals 507-519 for a single current collector, in order to determine an accurate measurement of the voltage of the current collector. For example, as shown, the current collectors 501b and 501c may not have any pair of the connection terminals 507-519 that is close to the spine of each of the current collectors 501c and 501d (e.g., farther than a predetermined distance based on an accuracy requirement for the battery module 300). Thus, as shown, a first pair of the connection terminals (509a, 509aa) may be connected the current collector 501b on a first side of the spine of the current collector 501b, while a second pair of the connection terminals (513a, 513aa) may be connected on a second side of the spine. That is, the current collector 501b includes first electrical connections to the first pair of the connection terminals (509a, 509aa) and second electrical connections to the second pair of the connection terminals (513a, 513aa) for the voltage measurement of the current collector 501b. As explained in greater detail below with reference to FIG. 8, by averaging the voltages measured by the first and second pairs of the connection terminals (“V1.1” and “V1.2”), an accurate voltage measurement of the current collector 501b may be obtained (e.g., by simulating a centered pair of connection terminals for the current collector 501b). Similarly, a third pair of the connection terminals (511a, 511aa) is connected to the current collector 501c on a first side of the spine of the current collector 501c, while a fourth pair of the connection terminals (515a, 515aa) is connected on a second side of the spine. By averaging the voltages measured by the third and fourth pairs of the connection terminals (“V2.1” and “V2.2”), an accurate voltage measurement of the current collector 501c may also be obtained. The first flex circuit 304a may include a first connector 505 for connecting the first flex circuit 304a with the processing circuitry 306, as explained in greater detail below with reference to FIG. 8.

As shown, an accurate voltage measurement (“V0”) of the current collector 501a may be obtained by connecting a single pair of the connection terminals (507a, 507aa) to the current collector 501a; an accurate voltage measurement (“V3”) of the current collector 501d may be obtained by connecting a single pair of the connection terminals (517a, 517aa) to the current collector 501d; and an accurate voltage measurement (“V4”) of the current collector 501e may be obtained by connecting a single pair of the connection terminals (519a, 519aa) to the current collector 501e. As shown, the single pair of connection terminals (517a, 517aa) is closer to the spine of the current collector 501d than any of the first pair of connection terminals (509a, 509aa) or the second pair of connection terminals (513a, 513aa) to the spine of the current collector 501b or the third pair of connection terminals (511a, 511aa) or the fourth pair of the connection terminals (515a, 515aa) to the spine of the current collector 501c. One and only one electrical connection between one of the current collectors 501 and the first flex circuit 304a refers to a connection of the current collector to either a single connection terminal or single pair of connection terminals of the first flex circuit 304a (e.g., to determine the voltage measurement of the current collector).

As shown, the battery module 300 with the first configuration of the first battery submodule 100a and the first configuration of the first flex circuit 304a is configured to determine five measurements of the plurality of current collectors 501 (e.g., a first number of measurements) and the first flex circuit 304a includes 14 connection terminals (seven pairs of connection terminals) (e.g., a number of connection terminals).

In some embodiments, instead of averaging voltage measurements by two pairs of the connection terminals, it may be advantageous to apply a correction factor (e.g., by the processing circuitry 306) to a voltage measurement by a single pair of the connection terminals, based on the distance of the single pair of connection terminals from the spine of the current collector. For example, as described in greater detail below with reference to FIG. 6, it may be advantageous to apply a correction factor to the voltage measurement (“V1.1”) of the current collector 501b measured by the first pair of the connection terminals (509a, 509aa) to obtain an accurate voltage measurement of the current collector 501b.

FIG. 6 shows a top view of the battery module 300 with a first configuration of the first battery submodule 100a of FIG. 5 and a second configuration of the first flex circuit 304a, in accordance with some embodiments of the present disclosure. The second configuration of the first flex circuit 304a may correspond to the first configuration of the first flex circuit 304a illustrated in FIG. 5, except that instead of connecting both of the first pair of the connection terminals (509a, 509aa) and the second pair of the connection terminals (513a, 513aa) to the current collector 501b, only the first pair of the connection terminals (509a, 509aa) is connected to the current collector 501b (e.g., and the second pair of the connection terminals (513a, 513aa) is not connected to any current collector). The first pair of the connection terminals (509a, 509aa) may be selected instead of the second pair of the connection terminals (513a, 513aa) based on the distance from each of the pairs to the spine of the current collector 501b (e.g., the pair that is closer to the spine may be selected). As described in greater detail below, a correction factor (e.g., to reduce measurement errors introduced by increased DCIR) may be applied to the voltage measurement (“V1.1”) of the current collector 501b by the first pair of the connection terminals (509a, 509aa) to obtain an accurate voltage measurement of the current collector 501b (e.g., based on the distance of the first pair of connection terminals (509a, 509aa) to the spine of the current collector 501b.

In some embodiments, it may be advantageous to connect only a single pair of the connection terminals (507-519) to each of the plurality of current collectors 501. For example, in some embodiments, it may be advantageous to also connect only a single pair of the connection terminals (e.g., the fourth pair of the connection terminals (515a, 515aa)) to the current collector 501c.

As shown, the battery module 300 with the first configuration of the first battery submodule 100a and the second configuration of the first flex circuit 304a is configured to have twelve individual electrical connections (or six pairs of electrical connections) (e.g., a number of electrical connections) between the first flex circuit 304a and the plurality of current collectors 501 among the 14 connection terminals 507-519 (or seven pairs of connection terminals) of the first flex circuit 304a (e.g., connection terminals 507, 509, 511, 515, 517, 519, a subset of connection terminals 507-519).

FIG. 7 shows a partial view of a connection of one pair of connection terminals 507a, 507aa of the first flex circuit 304a to one of the plurality of current collectors 501a, in accordance with some embodiments of the present disclosure. As shown, the connection terminal 507a may be electrically coupled to a first location of the current collector 501a by a ribbon 701. In some embodiments, the ribbon 701 may be connected to the connection terminal 507a and the first location of the current collector 501a by laser welding. In some embodiments, if the current collector 501a and the ribbon 701 are made of different materials (e.g., nickel and aluminum), it may be advantageous to apply an adhesive 703 above the portion of the ribbon 701 in contact with the current collector 501a, so that once the adhesive 703 is cured, the adhesive 703 isolates the portion of the ribbon 701 in contact with the current collector 501a from air, thereby preventing corrosion at the connection due to the difference in the galvanic corrosion potential of nickel and aluminum. FIG. 7 also illustrates one embodiment of the connection between the current collector 501a and battery cells 103 (e.g., of the first parallel group 503a). However, this is only one example, and the battery cells 103 may be connected to the current collectors 501 in any suitable manner.

FIG. 8 shows a block diagram of an adaptor 801 for connecting the first flex circuit 304a to the processing circuitry 306, in accordance with some embodiments of the present disclosure. In some embodiments, it may be advantageous for the processing circuitry 306 to be universal processing circuitry that can be used across the different configurations of the battery submodule 100a and the first flex circuit 304a. In some embodiments, the processing circuitry 306 may include a connector with a plurality of pins (e.g., V0-V6) that connect with respective pins of the connector 505 of the first flex circuit 304a. As shown, the first flex circuit 304a includes a plurality of conductive traces 805 having the connection terminals 507-519 at one end (e.g., that may be coupled to the plurality of current collectors) and output terminals at the opposite end (e.g., pins of the connector 505). Based on the configuration of the battery submodule 100a and the first flex circuit 304a, operations of the plurality of pins of the processing circuitry 306 may be reconfigured (e.g., by hardware or software) in order to correctly interpret voltage measurements from the first flex circuit 304a.

In some embodiments, it may be advantageous to include an adaptor (e.g., the adaptor 801) that correctly routes the plurality of pins of the connector 505 to the plurality of pins of the processing circuitry 306. In this case, the processing circuitry 306 does not need to be reconfigured for different configurations of the battery submodule 100a and the first flex circuit 304a. For example, as shown, the processing circuitry 306 may include seven pairs of pins (V0 and V0; V1 and V1; V2 and V2; V3 and V3; V4 and V4; V5 and V5; V6 and V6). The processing circuitry 306 may be configured to determine a voltage of up to six parallel groups of battery cells 103 (e.g., by averaging the measurement values at each pair of pins if redundant measurements for each current collector are implemented). If, however, the connector 505 of the first flex circuit 304a having the second configuration illustrated in FIG. 6 is directly connected to the processing circuitry 306, the processing circuitry 306 will not correctly determine the voltages of each of the four parallel groups of battery cells (503a, 503b, 503c, 503d). Thus, as shown, the adaptor 801 may route the connection terminals 507a, 507aa to the first pair of pins V0, V0 of the processing circuitry 306 and route the connection terminals 509a, 509aa to the second pair of pins V1, V1 of the processing circuitry 306. The adaptor 801 may include combination logic 803 (e.g., hardware or software) for combining and routing the connection terminals 511a, 511aa, 515a, 515aa to the third pair of pins V2, V2, of the processing circuitry 306. For example, the adaptor 801 may connect both of the connection terminals 511a, 511aa to a first one of the third pair of pins V2 and connect both of the connection terminals 515a, 515aa to a second one of the third pair of pins V2. Further, the adaptor 801 may route the connection terminals 517a, 517aa to the fourth pair of pins V3, V3 of the processing circuitry 306 and route the connection terminals 519a, 519aa to the fifth pair of pins V4, V4 of the processing circuitry 306. Because the connection terminals 513a, 513aa are not connected to any current collector, the adaptor 801 refrains from routing these terminals to the processing circuitry 306. Thus, the processing circuitry 306 may correctly identify the voltages of each of the four parallel groups of battery cells (503a, 503b, 503c, 503d, without reconfiguration of the pins of the processing circuitry 306.

Although the processing circuitry 306 is illustrated with a pair of pins for each current collector, this is only an example, and in some embodiments, the adaptor 801 may combine the voltages from pairs of the connection terminals 507-519 (e.g., by merging conductive traces of each pair together). In that case, the number of pins of the processing circuitry 306 may be reduced. For example, the number of pins could be reduced from fourteen (seven pairs of pins) to seven.

In view of the foregoing, by providing the modular components discussed above (e.g., a universal flex circuit and universal processing circuitry), manufacturing of battery submodules having different configurations (e.g., different numbers of parallel groups of battery cells) and battery modules including one or more of the battery submodules may be greatly simplified. For example, based on the maximum number of parallel groups of battery cells that are expected to be included in a battery submodule, a flex circuit that is suitable for connecting this maximum number of parallel groups to processing circuitry (e.g., a battery voltage and temperature (BVT) acquisition unit) may be manufactured. Similarly, processing circuitry that is also suitable for monitoring the voltage of each of the current collectors connecting the battery cells may be manufactured or configured. Thereafter, the manufactured flex circuit and processing circuitry may be easily installed on any battery submodule having the maximum number or fewer number of parallel groups. For example, for a current collector having a connection terminal (or pair of connection terminals) of the flex circuit substantially centered on the current collector, the single connection terminal (or single pair of connection terminals) (i.e., “one and only one connection terminal”) may be electrically connected to the current collector for a measurement of the current collector. For a current collector not having a connection terminal (or pair of connection terminals) of the flex circuit substantially centered on the current collector, multiple connection terminals (or multiple pairs of terminals) may be electrically connected to the current collector for a measurement of the current collector (e.g., by combining the measurements of the multiple connection terminals (or multiple pairs of connection terminals)). Additionally, in some embodiments, an adaptor corresponding to the configurations of the flex circuit and the battery submodule, may be selected and used to connect the flex circuit to the processing circuitry.

Each of the components used in the assembly of battery submodules and the battery modules including one or more of the battery submodules may be provided by manufacturing or assembling the component itself, or by obtaining the component from a supply of components. For example, obtaining a particular component (e.g., the processing circuitry 306) may include selecting the particular component from a plurality of types of configurations of the component, by modifying the particular component by an additional component (e.g., selecting or configuring the adaptor 801 for connecting the processing circuitry 306 to the first flex circuit 304a), or by configuring the particular component (e.g., configuring inputs of the processing circuitry 306 to correspond to the configurations of the first flex circuit 304a and the battery submodule 100a).

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A battery module, comprising:
a plurality of current collectors configured to electrically connect battery cells together; and
a flex circuit, wherein:
the battery module is configured to have a number of electrical connections between the plurality of current collectors and the flex circuit;
the flex circuit comprises a number of connection terminals, each capable of being electrically coupled to a current collector of the plurality of current collectors;
the number of connection terminals is greater than the number of electrical connections; and
the electrical connections are between the plurality of current collectors and a subset of the connection terminals of the flex circuit.

2. The battery module of claim 1, wherein the flex circuit is a universal flex circuit that is capable of being used with multiple battery module configurations having different numbers of current collectors.

3. The battery module of claim 1, wherein:
the connection terminals comprise one or more voltage tap locations;
the battery cells are arranged into n−1 number of a plurality of groups; and
the plurality of current collectors comprises n number of current collectors configured to electrically connect the battery cells in each of the plurality of groups in parallel with each other and electrically connect each of the plurality of groups in series with each other.

4. The battery module of claim 3, wherein the number of electrical connections is equal to n and the number of connection terminals is greater than n.

5. The battery module of claim 3, wherein the number of electrical connections is equal to 2n and the number of connection terminals is greater than 2n.

6. The battery module of claim 1, wherein:
the flex circuit further comprises a plurality of conductive traces and a plurality of output terminals;
for each of the plurality of conductive traces, one of the connection terminals is connected to a first end of the conductive trace and one of the output terminals is connected to a second end of the conductive trace; and
only a subset of the output terminals, which are connected to the subset of the connection terminals, are configured to be electrically coupled to a voltage-measuring device configured to measure a voltage level at the subset of the connection terminals of the flex circuit.

7. The battery module of claim 6, wherein the voltage-measuring device is selected from a plurality of types of configurations of voltage-measuring devices, based on the number of electrical connections made between the plurality of current collectors and the subset of the connection terminals of the flex circuit.

8. The battery module of claim 6, further comprising an adaptor configured to selectively electrically connect only a subset of the plurality of output terminals to the voltage-measuring device, based on the number of electrical connections made between the plurality of current collectors and the subset of the connection terminals of the flex circuit.

9. The battery module of claim 1, wherein:
the flex circuit extends from one side of the battery module across the battery module along a first direction;
each of the plurality of current collectors comprises:
a spine that traverses the battery module along a second direction substantially perpendicular to the first direction; and
a plurality of projections that extend from the spine; and
for each of the plurality of current collectors, a connection terminal, among the connection terminals, that is closest to the spine of the current collector is selected as the connection terminal to be electrically connected to the current collector.

10. A battery module, comprising:
a plurality of current collectors configured to electrically connect battery cells together; and
a flex circuit, wherein:
the battery module is configured for determining a number of measurements of the plurality of current collectors;
the flex circuit comprises a number of connection terminals, each capable of being electrically coupled to a current collector of the plurality of current collectors;
the number of connection terminals is greater than the number of measurements;
a first current collector of the plurality of current collectors comprises one and only one electrical connection to the flex circuit for one of the measurements; and
a second current collector of the plurality of current collectors comprises two electrical connections to the flex circuit for a corresponding one of the measurements.

11. The battery module of claim 10, wherein:
the connection terminals comprise one or more voltage tap locations;
the flex circuit further comprises a plurality of conductive traces and a plurality of output terminals; and
for each of the plurality of conductive traces, one of the connection terminals is connected to a first end of the conductive trace and one of the output terminals is connected to a second end of the conductive trace.

12. The battery module of claim 11, wherein:
the flex circuit extends from one side of the battery module across the battery module along a first direction;
each of the plurality of current collectors comprises:
a spine that traverses the battery module along a second direction substantially perpendicular to the first direction; and
a plurality of projections that extend from the spine;
for the first current collector, the one and only electrical connection to the flex circuit is by a first connection terminals;
for the second current collector, the two electrical connections to the flex circuit are by second and third connection terminals; and
the first connection terminal is closer to the spine of the first current collector than either of the second and third connection terminals is to the spine of the second current collector.

13. The battery module of claim 12, wherein for each of the first, second, and third connection terminals, the corresponding output terminal is configured to be electrically connected to a voltage-measuring device.

14. The battery module of claim 13, wherein the voltage-measuring device is configured to combine the output terminals corresponding to the second and third connection terminals for one of the measurements.

15. The battery module of claim 14, wherein the voltage-measuring device comprises an adaptor configured to combine the output terminals corresponding to the second and third connection terminals.

16. The battery module of claim 10, further comprising:
a voltage-measuring device configured to determine the number of measurements; and
a connector configured to electrically connect the flex circuit to the voltage-measuring device.

17. A method of manufacturing, comprising:
providing a flex circuit to be installed in a battery module comprising a current collector configuration for electrically connecting a plurality of batteries, wherein the flex circuit comprises a connector;
selecting a voltage-measuring device of a first configuration from a plurality of types of configurations of voltage-measuring devices, based on the current collector configuration of the battery module;
installing the flex circuit in the battery module; and
coupling the selected voltage-measuring device to the connector of the flex circuit.

18. The method of manufacturing of claim 17, wherein:
the flex circuit comprises a number of connection terminals, each capable of being electrically connected to a current collector; and
installing the flex circuit in the battery module comprises making a number of electrical connections between the current collector configuration and a subset of the connection terminals of the flex circuit, the number of connection terminals being greater than the number of electrical connections.

19. The method of manufacturing of claim 17, wherein:
the flex circuit comprises a number of connection terminals, each capable of being electrically connected to a current collector; and
installing the flex circuit in the battery module comprises:
making one and only one electrical connection between a first current collector of the current collector configuration and the connection terminals of the flex circuit for a first measurement of the first current collector; and
making two electrical connections between a second current collector of the current collector configuration and two of the connection terminals of the flex circuit for a second measurement of the second current collector.

20. The method of manufacturing of claim 17, wherein selecting the voltage-measuring device of the first configuration comprises selecting an adaptor configured to route certain electrical output terminals of the flex circuit to certain input terminals of the voltage-measuring device, based on the current collector configuration of the battery module.
